(19) United States
(12) Patent Application Publication
(10) Pub. No.: US 2014/0233550 A1
(43) Pub. Date: Aug. 21, 2014

(54) LOCATION DETERMINATION

(71) Applicant: Apple Inc., Cupertino, CA (US)

(72) Inventor: Christopher J. Hansen, Los Altos, CA (US)

(73) Assignee: APPLE INC., Cupertino, CA (US)

(21) Appl. No.: 14/181,501

(22) Filed: Feb. 14, 2014

Related U.S. Application Data
(60) Provisional application No. 61/766,008, filed on Feb. 18, 2013.

(51) Int. Cl. H04W 4/02

(52) U.S. Cl. CPC H04W 4/023
USPC 370/338

(57) ABSTRACT

Method and apparatus for location determination by a wireless communication device is disclosed. The method includes a wireless communication device at least formatting a message defined to trigger initiation of a timing measurement exchange; sending the message to trigger initiation of the timing measurement exchange; monitoring a timing measurement exchange between a plurality of access points as part of the timing measurement exchange initiated in response to the message; and determining a location of the wireless communication device based on the timing measurement exchange.

### CROSS-REFERENCE TO RELATED APPLICATIONS

This application claims the benefit of U.S. Provisional Patent Application No. 61/766,008, filed Feb. 18, 2013, and entitled “LOCATION DETERMINATION,” which is incorporated herein by reference in its entirety for all purposes.

### FIELD

The described embodiments generally relate to wireless communications technology, and more particularly to location determination using a wireless communication device within a wireless local area network (WLAN).

### BACKGROUND

Wireless communication devices are often used within large facilities, such as airports, office complexes, stadiums, and the like, which can have a WLAN that includes a plurality of access points. A user of such a wireless communication device can wish to know his or her location within a facility, such as for purposes of indoor navigation. Techniques have been developed for a wireless communication device to determine its location based on signaling that can occur between access points of a WLAN. In this regard, WLAN access points can be aware of their deployment location and can transmit indications of their respective locations, which can be received by a wireless communication device. The access point can engage in a timing measurement procedure, which can include one or more timing measurement exchanges. A wireless communication device can receive timing measurement messages exchanged by access points, and based on a time of receipt of the timing messages, the wireless communication device can determine its location relative to the access points. In combination with knowledge of the access points' locations, the wireless communication device can calculate its own location.

While these techniques have been developed to enable a wireless communication device to determine its location, wireless communication devices can be in a sleep state when access points engage in a timing measurement procedure. In this regard, wireless communication devices can be configured to operate in a power save mode and can wake up from the power save mode for specific reasons, such as to associate with an access point, to transmit or to receive data, to receive beacons from an access point, or to scan for access points. A wireless communication device that is in a power save mode cannot monitor/hear the timing measurement exchanges, and thus the wireless communication device cannot determine its location.

### SUMMARY

This paper describes various embodiments that relate to location determination based on a timing measurement exchange between a plurality of access points of a wireless network.

In one embodiment, a method for determining a location of a wireless communication device is disclosed. The method can be carried out by the wireless communication device. The method includes the wireless communication device sending, to a first access point, a request to initiate a timing measure measurement exchange. In this way, sending the request to the first access point causes the first access point to initiate the timing measurement exchange with a second access point. The method further includes the wireless communication device receiving a first report message from the first access point and a second report message from the second access point. The first and second report messages can be based on the timing measurement exchange. Upon receiving the first and second report messages, the wireless communication device can determine a location of the wireless communication device based on the first and second report messages. In one aspect of the embodiment the wireless communication device is configured to operate as a WLAN station. In another aspect of the embodiment, the request can include a probe request or an authentication request.

In another embodiment, a method for determining a location of a wireless communication device is disclosed. The method can be carried out by a first access point of a wireless network. The method includes receiving a message from the wireless communication device. The message indicates that the wireless communication device requests that the first access point initiate a timing measurement exchange with one or more access points. Upon receiving the message, the first access point initiates a timing measurement exchange with a second access point by sending the second access point a timing message. The method further includes the first access point sending a first report message based on the sent timing message. Next, the first access point can receive an acknowledgement message from the second access point. In one aspect of the embodiment, sending the timing message to the second access point causes the second access point to send a second report message to the wireless communication device.

In another embodiment, a non-transitory computer readable storage medium is disclosed. The non-transitory computer readable storage medium is configured to store instructions that, when executed by a processor included in a wireless communication device, cause the wireless communication device to perform a number of actions. The wireless communication device formats a message that causes a timing measurement exchange between a plurality of access points. The wireless communication device sends the message to at least one of the plurality of access points, thereby causing the timing measurement exchange between the plurality of access points. Subsequent to sending the message, the wireless communication device operates in an awake state for a least a portion of time during the timing measurement exchange. Next, the wireless communication device monitors the timing measurement exchange and determine a location of the wireless communication device based on information received from the plurality of access points during the timing measurement exchange. In one aspect of the embodiment, the wireless communication device is configured to communicate with the plurality of access points in accordance with an Institute of Electrical and Electronics Engineers (IEEE) 802.11 wireless communication protocol.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a wireless communication system, in accordance with some embodiments.

FIG. 2 illustrates a logical ladder diagram of a timing measurement exchange, in accordance with some embodiments.

FIG. 3 illustrates a block diagram of an apparatus that can be implemented in a wireless communication device operating as a WLAN station, in accordance with some embodiments.

FIG. 4 illustrates a block diagram of an apparatus that can be implemented in an access point, in accordance with some embodiments.

FIG. 5 illustrates a flow chart of a method for determining a location of a wireless communication device, in accordance with some embodiments.

FIG. 6 illustrates another flow chart of a method for determining a location of a wireless communication device, in accordance with some embodiments.

### DETAILED DESCRIPTION

Representative applications of systems, methods, apparatuses, and computer program products according to the present disclosure are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Some embodiments provide a solution to the current uncoordinated approach by which WLAN access points engage in timing measurement exchanges. In this regard, present timing measurement exchanges are performed by WLAN access points without any coordination with other wireless communication devices, such as WLAN stations, which can also be referred to as WLAN client devices. Thus, wireless communication devices can frequently miss timing measurement messages exchanged between WLAN access points, as wireless communication devices are often asleep, so as to save power, when a timing measurement exchange between WLAN access points occurs. Some embodiments accordingly define protocols by which wireless communication devices can send a message to trigger a WLAN access point to initiate a timing measurement exchange. As such, a timing measurement exchange can be performed when a wireless communication device is in an awake state, e.g., in response to the triggering message, and the wireless communication device can monitor the timing measurement messages to ascertain its location. Wireless communication devices can accordingly benefit by being able to determine their locations from a timing measurement exchange that can be triggered on demand without having to remain awake for a substantial additional period of time in order to listen for timing measurement messages that might otherwise be randomly exchanged between access points. Thus, some embodiments facilitate location determination by a wireless communication device without imposing any significant additional power consumption burden on the wireless communication device. Furthermore, some embodiments avoid clogging a wireless communication channel with timing measurement messages that might not be heard or used by a wireless communication device by providing a means for initiation of a timing measurement exchange on demand.

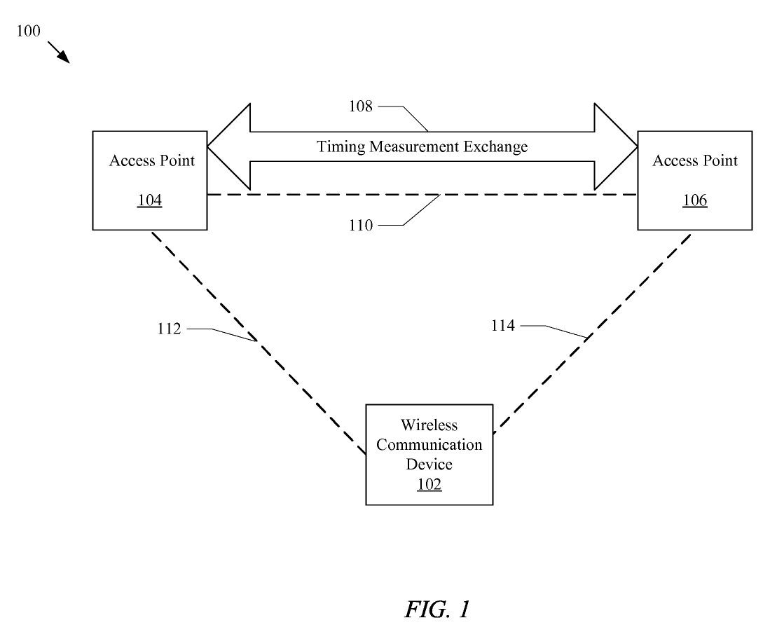

FIG. 1 illustrates a wireless communication system 100 in accordance with some embodiments. The wireless communication system 100 can include a wireless communication device 102. By way of non-limiting example, the wireless communication device 102 can be embodied as a cellular phone, such as a smart phone device, a tablet computing device, a laptop computing device, and/or other computing device that can be configured to communicate over one or more wireless networks. In some embodiments, the wireless communication device 102 can be configured to operate as a WLAN station on a WLAN that operates in accordance with an IEEE 802.11 technology, such as based on 802.11a, 802.11b, 802.11g, 802.11n, 802.11ac, 802.11 ad wireless communication protocols, and/or the like. However, it will be appreciated that embodiments described herein using WLAN and/or 802.11 techniques are provided by way of example, and not by way of limitation. In this regard, embodiments described herein can be applied to wireless networks using other technologies/protocols in which a wireless communication device can obtain network access via an access point.

The wireless communication system 100 can further include a plurality of access points. An access point 104 and an access point 106 are illustrated by way of example. It will be appreciated, however, that the wireless communication system 100 can include additional access points. The access point 104 and the access point 106 can be configured to provide access to a wireless network. For example, the access point 104 and the access point 106 can be WLAN access points. The wireless communication device 102 can be within a signaling range of the access point 104 and/or the access point 106 and can be configured to associate with the access point 104 and/or the access point 106 to obtain access to the wireless network. The access point 104 and the access point 106 can be separated by a distance 110 from each other. Furthermore, the wireless communication device 102 can be positioned at a distance 112 and at a distance 114 from the access point 104 and from the access point 106 respectively.

The access point 104 and the access point 106 can be configured to engage in a timing measurement procedure, which can include a timing measurement exchange 108. The timing measurement exchange 108 can include one of the access points (e.g., access point 104) sending a timing message to the other access point (e.g., access point 106), which can, in response to receipt of the timing message, send an acknowledgement message to the access point that sent the timing message (e.g., access point 104). The wireless communication device 102 can be configured to monitor the timing measurement exchange 108 and to calculate one or more of the distance 110 between the access points, the distance 112 between the wireless communication device 102 and the access point 104, and the distance 114 between the wireless communication device 102 and the access point 106 based on information contained in or associated with the timing measurement exchange 108.

As will be described further herein, the wireless communication device 102 can be configured to send a message, which can be referred to as an initiation message, to one or more access points of a wireless network, e.g., access point 104 and/or access point 106. The initiation message can trigger an access point to initiate a timing measurement exchange 108 with one or more other access points so that the wireless communication device 102 can monitor the timing measurement exchange 108 and can calculate a location of the wireless communication device 102 on demand. The access point 104 and/or the access point 106 can accordingly be configured to initiate the timing measurement exchange 108 in response to receipt of the initiation message.

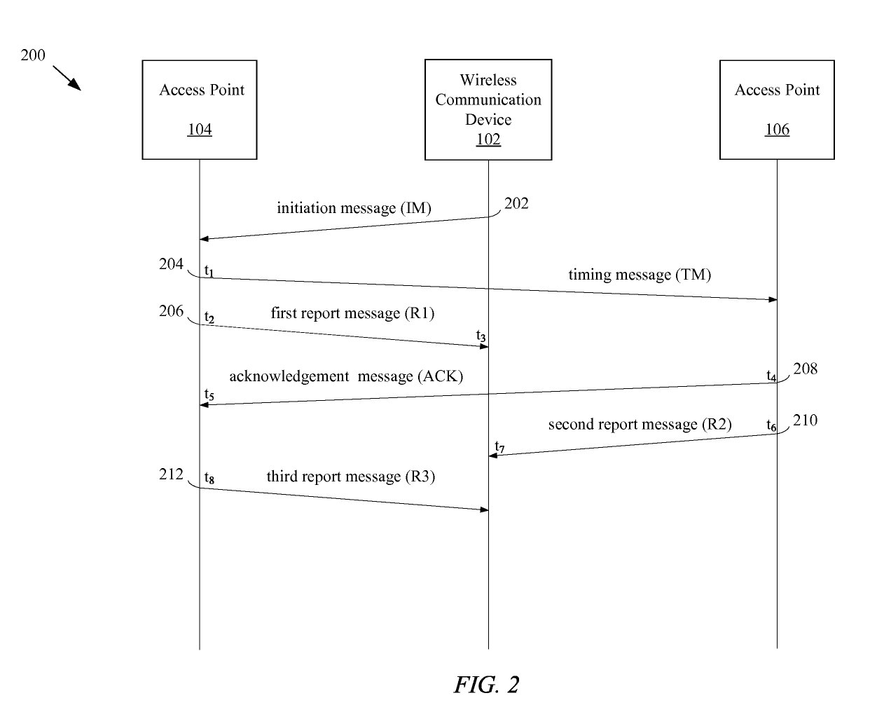

FIG. 2 illustrates a diagram 200 representing a timing measurement exchange in accordance with some embodiments. The timing measurement exchange can be carried out by the access point 104, the access point 106, and the wireless communication device 102. At 202, the wireless communication device 102 sends to the access point 104 an initiation message (IM). The IM causes the access point 104 to initiate a timing measurement exchange with the access point 106. At 204, the timing measurement exchange begins when the access point 104 sends to the access point 106 a timing message (TM). The TM can be sent at time t₁. At 206, the access point 104 can send to the wireless communication device 102 a first report message (R1). The first report message R1 can include a time t₂ that indicates when R1 was sent by the access point 104. In some embodiments, the first report message R1 is sent substantially concurrent with the timing message TM (i.e., t₁≈t₂). In some embodiments, the first report message R1 is a copy of the timing message TM. Upon receiving the first report message R1, the wireless communication device 102 can record a time t₃ that indicates when the first report message R1 was received by the wireless communication device 102.

In response to receiving the timing message TM, the access point 106 sends to the access point 104 an acknowledgement message (ACK) at 208. The ACK is sent from the access point 106 at time t₄ and is received by the access point 104 at time t₅. At 210, the access point 106 can send the wireless communication device 102 a second report message (R2). The second report message R2 can include an indication of the times t₄ and t₆. In some embodiments, the second report message R2 is sent by the access point 106 substantially concurrent with the ACK (i.e., t₄≈t₆). In some embodiments, the second report message R2 is a copy of the ACK. The wireless communication device 102 can record a time t₇ that indicates when the second report message R2 was received by the wireless communication device 102. At 212, the access point 104 sends to the wireless communication device 102 a third report message (R3). The third report message R3 can include an indication of a time t₅ when the access point 104 received the ACK. The third report message R3 can also include an indication of a time t₈ when the access point 104 sent the third report message, and/or a round-trip-time (RTT) report of the timing measurement exchange (e.g., an indication of the time difference t₅-t₁).

The wireless communication device 102 can use information received during the timing measurement exchange to calculate a location of the wireless communication device 102. In some embodiments, the wireless communication device 102 can calculate the distance 112 between the access point 104 and the wireless communication device 102, and the distance 114 between the access point 106 and the wireless communication device 102. The calculated distances 112/114 can be used to determine a location of the wireless communication device 102. For example, the wireless communication device 102 can calculate the distance 112 and the distance 114 by using any of (i) the times t₁ through t₈, (ii) a duration of time for a message to travel between access points 104 and 106 (e.g., T, a time of flight), and (iii) a speed at which any message travels (e.g., the speed of light). The time of flight, T, can be known to the wireless communication device 102 based on information provided by the access points 104/106 (e.g., an RTT report). In another example, the wireless communication device 102 can calculate a differential distance with respect to the access points 104/106 (i.e., a difference between the distance 112 and the distance 114).

In some embodiments, the calculated location of the wireless communication device 102 can be a location based on a geographical coordinate system (e.g., latitude, longitude, elevation) and/or a relative location with respect to the access point 104 and/or the access point 106. In some embodiments, the wireless communication device 102 can use hyperbolic navigation to determine a location of the wireless communication device 102 based on the distance 112 and the distance 114. A hyperbolic navigation operation can include calculating potential locations of the wireless communication device 102 with respect to the access point 104 and the access point 106. For example, the access point 104 can be at the center of a first circle having a radius of a distance 112 and the access point 106 can be at the center of a second circle having a radius of a distance 114. The first circle and the second circle can intersect at a first intersection location and at a second intersection location. Since the wireless communication device 102 is positioned at a distance 112 from the access point 104 and positioned at a distance 114 from the access point 106, it can be deduced that the wireless communication device 102 is located at either the first intersection location or the second intersection location. Determining the first intersection location and the second intersection location can be performed by the wireless communication device 102 by performing functions on the data (e.g., t₁, t₂, T, etc.) that the wireless communication device 102 received during a timing measurement exchange between the access point 104 and the access point 106. The functions can be based on differential distance equations, geometric equations, and/or the like. Furthermore, in conjunction with other information, the wireless communication device 102 can eliminate either the first intersection location or the second intersection location as a location possibility. For example, in the case where the wireless communication device 102 is positioned at a third distance from a third access point, the third access point can be at the center of a third circle having a radius of the third distance. In this regard, the wireless communication device 102 can be located at a location where the first, second, and third circles intersect. In some embodiments, the wireless communication device 102 can determine the third distance from the third access point by causing the third access point to initiate a timing measurement exchange and monitoring the timing measurement exchange in accordance with the described embodiments.

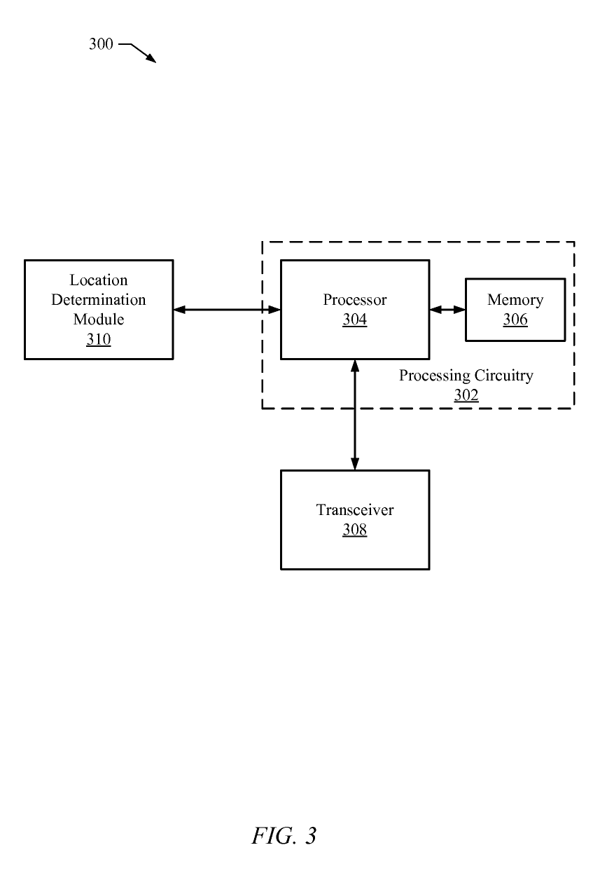

FIG. 3 illustrates a block diagram of an apparatus 300 that can be implemented in a wireless communication device 102 operating as a WLAN station in accordance with some embodiments. In this regard, when implemented or included in a computing device, such as wireless communication device 102, apparatus 300 can enable the computing device to operate within the wireless communication system 100 in accordance with one or more embodiments. It will be appreciated that the components, devices or elements illustrated in and described with respect to FIG. 3 may not be mandatory and thus some may be omitted in certain embodiments. Additionally, some embodiments can include further or different components, devices or elements beyond those illustrated in and described with respect to FIG. 3.

In some embodiments, the apparatus 300 can include processing circuitry 302 that can be configured to perform actions in accordance with one or more embodiments disclosed herein. In this regard, the processing circuitry 302 can be configured to perform and/or control performance of one or more functionalities of the apparatus 300 in accordance with various embodiments, and thus can provide means for performing functionalities of the apparatus 300 in accordance with various embodiments. The processing circuitry 302 can be configured to perform data processing, application execution and/or other processing and management services according to one or more embodiments.

In some embodiments, the apparatus 300 or a portion(s) or component(s) thereof, such as the processing circuitry 302, can include one or more chipsets, which can each include one or more chips. The processing circuitry 302 and/or one or more further components of the apparatus 300 can therefore, in some instances, be configured to implement an embodiment on a chipset comprising one or more chips. In some embodiments in which one or more components of the apparatus 300 are embodied as a chipset, the chipset can be capable of enabling a computing device to operate in the wireless communication system 100 when implemented on or otherwise operably coupled to the computing device. Thus, for example, one or more components of the apparatus 300 can provide a chipset configured to enable a computing device to communicate using one or more wireless network technologies.

In some embodiments, the processing circuitry 302 can include a processor 304 and, in some embodiments, such as that illustrated in FIG. 3, can further include memory 306. The processing circuitry 302 can be in communication with or otherwise control a transceiver 308 and/or a location determination module 310.

The processor 304 can be embodied in a variety of forms. For example, the processor 304 can be embodied as various processing hardware-based means such as a microprocessor, a coprocessor, a controller or various other computing or processing devices including integrated circuits such as, for example, an application specific integrated circuit (ASIC), a field programmable gate array (FPGA), some combination thereof, or the like. Although illustrated as a single processor, it can be appreciated that the processor 304 can include a plurality of processors. The plurality of processors can be in operative communication with each other and can be collectively configured to perform one or more functionalities of the apparatus 300 as described herein. In some embodiments, the processor 304 can be configured to execute instructions that can be stored in the memory 306 or that can be otherwise accessible to the processor 304. As such, whether configured by hardware or by a combination of hardware and software, the processor 304 can be capable of performing operations according to various embodiments while configured accordingly.

In some embodiments, the memory 306 can include one or more memory devices. Memory 306 can include fixed and/or removable memory devices. In some embodiments, the memory 306 can provide a non-transitory computer-readable storage medium that can store computer program instructions that can be executed by the processor 304. In this regard, the memory 306 can be configured to store information, data, applications, instructions and/or the like for enabling the apparatus 300 to carry out various functions in accordance with one or more embodiments. In some embodiments, the memory 306 can be in communication with one or more of the processor 304, the transceiver 308, or the location determination module 310 via a bus(es) for passing information among components of the apparatus 300.

The apparatus 300 can further include the transceiver 308. The transceiver 308 can be configured to enable the apparatus 300 to send and receive wireless signals in accordance with one or wireless networking technologies. As such, the transceiver 308 can enable the apparatus 300 to send signals to and receive signals from access point 104 and/or access point 106.

The apparatus 300 can further include the location determination module 310. The location determination module 310 can be embodied as various means, such as circuitry, hardware, a computer program product comprising computer readable program instructions stored on a computer readable medium, e.g., the memory 306, and executed by a processing device, e.g., the processor 304, or some combination thereof. In some embodiments, the processor 304 (or the processing circuitry 302) can include, or otherwise control the location determination module 310.

The location determination module 310 can be configured to send a message that can be received by the access point 104 and/or the access point 106 to trigger a timing measurement exchange between the access points 104/106. The location determination module 310 can be further configured to determine a location of the wireless communication device 102 based at least in part on the timing measurement exchange.

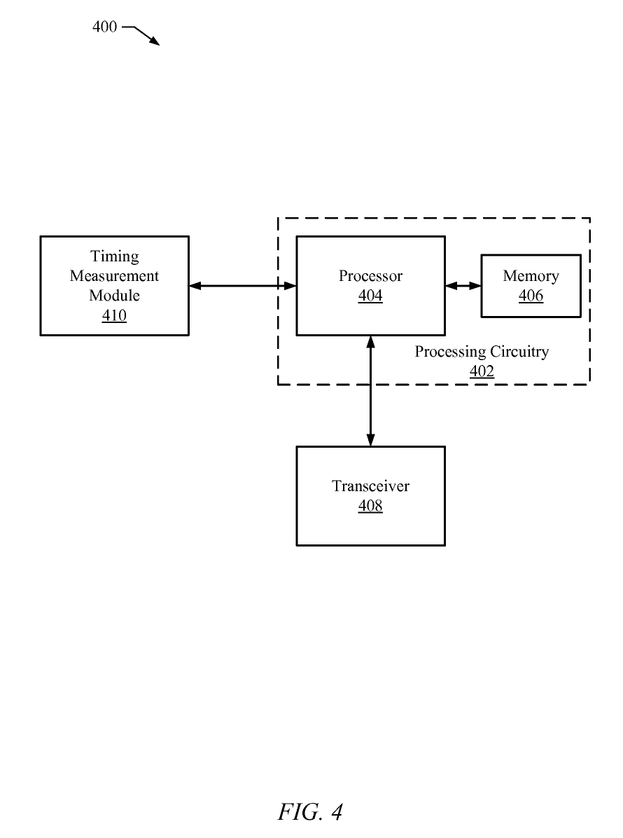

FIG. 4 illustrates a block diagram of an apparatus 400 that can be implemented in an access point, such as the access point 104 and/or the access point 106, in accordance with some embodiments. In this regard, when implemented or included in an access point, apparatus 400 can enable the access point to operate as an access point within the wireless communication system 100 in accordance with one or more embodiments. It will be appreciated that the components, devices or elements illustrated in and described with respect to FIG. 4 below may not be mandatory and thus some may be omitted in certain embodiments. Additionally, some embodiments can include further or different components, devices or elements beyond those illustrated in and described with respect to FIG. 4.

In some embodiments, the apparatus 400 can include processing circuitry 402 that can be configured to perform actions in accordance with one or more embodiments disclosed herein. In this regard, the processing circuitry 402 can be configured to perform and/or control performance of one or more functionalities of the apparatus 400 in accordance with various embodiments, and thus can provide means for performing functionalities of the apparatus 400 in accordance with various embodiments. The processing circuitry 402 can be configured to perform data processing, application execution and/or other processing and management services according to one or more embodiments.

In some embodiments, the apparatus 400 or a portion(s) or component(s) thereof, such as the processing circuitry 402, can include one or more chipsets, which can each include one or more chips. The processing circuitry 402 and/or one or more further components of the apparatus 400 can therefore, in some instances, be configured to implement an embodiment on a chipset comprising one or more chips. In some embodiments in which one or more components of the apparatus 400 are embodied as a chipset, the chipset can be capable of enabling a computing device to operate as an access point in the wireless communication system 100 when implemented on or otherwise operably coupled to the computing device.

In some embodiments, the processing circuitry 402 can include a processor 404 and, in some embodiments, such as that illustrated in FIG. 4, can further include memory 406. The processing circuitry 402 can be in communication with or otherwise control a transceiver 408 and/or a timing measurement module 410.

The processor 404 can be embodied in a variety of forms. For example, the processor 404 can be embodied as various processing hardware-based means such as a microprocessor, a coprocessor, a controller or various other computing or processing devices including integrated circuits such as, for example, an ASIC, an FPGA, some combination thereof, or the like. Although illustrated as a single processor, it will be appreciated that the processor 404 can include a plurality of processors. The plurality of processors can be in operative communication with each other and can be collectively configured to perform one or more functionalities of the apparatus 400 as described herein. In some embodiments, the processor 404 can be configured to execute instructions that can be stored in the memory 406 or that can be otherwise accessible to the processor 404. As such, whether configured by hardware or by a combination of hardware and software, the processor 404 can be capable of performing operations according to various embodiments while configured accordingly.

In some embodiments, the memory 406 can include one or more memory devices. Memory 406 can include fixed and/or removable memory devices. In some embodiments, the memory 406 can include a non-transitory computer-readable storage medium that can store computer program instructions that can be executed by the processor 404. In this regard, the memory 406 can be configured to store information, data, applications, instructions and/or the like for enabling the apparatus 400 to carry out various functions in accordance with one or more embodiments. In some embodiments, the memory 406 can be in communication with one or more of the processor 404, the transceiver 408, or the timing measurement module 410 via a bus(es) for passing information among components of the apparatus 400.

The apparatus 400 can further include the transceiver 408. The transceiver 408 can be configured to enable the apparatus 400 to send and receive wireless signals in accordance with one or wireless networking technologies. As such, the transceiver 408 can enable the apparatus 400 to send signals to and receive signals from another access point(s) and WLAN stations, such the wireless communication device 102.

The apparatus 400 can further include the timing measurement module 410. The timing measurement module 410 can be embodied as various means, such as circuitry, hardware, a computer program product comprising computer readable program instructions stored on a computer readable medium, e.g., the memory 406, and executed by a processing device, e.g., the processor 404, or some combination thereof. In some embodiments, the processor 404 (or the processing circuitry 402) can include, or otherwise control the timing measurement module 410.

The timing measurement module 410 can be configured to receive an initiation message that can be sent by a WLAN station, such as the wireless communication device 102, to trigger a timing measurement exchange. The timing measurement module 410 can be further configured to initiate a timing measurement exchange in response to receipt of the initiation message and to exchange appropriate timing measurement messages with one or more other access points.

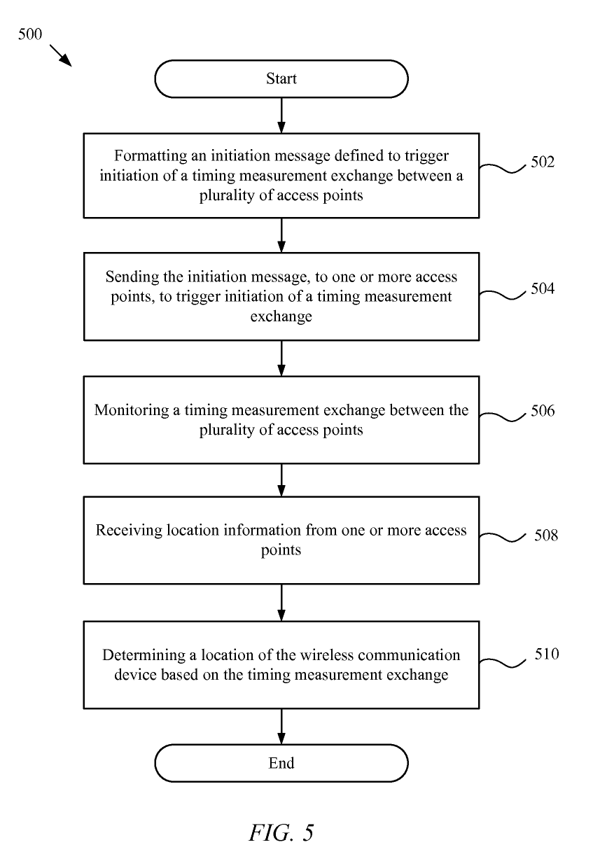

FIG. 5 illustrates a flow chart 500 of a method for location determination of a wireless communication device in accordance with some embodiments. In this regard, FIG. 5 illustrates steps that can be performed by the wireless communication device 102 in accordance with various embodiments. One or more of processing circuitry 302, processor 304, memory 306, transceiver 308, or location determination module 310 can, for example, provide means for performing the steps illustrated in and described with respect to FIG. 5.

Step 502 can include formatting an initiation message defined to trigger initiation of a timing measurement exchange between access points, such as access point 104 and access point 106. Step 504 can include sending the initiation message so that it can be received by one or more access points, such as access point 104 and/or access point 106.

In some embodiments, the initiation message is formatted such that the wireless communication device 102 operates in an awake state for a duration of time subsequent to sending the initiation message. In an awake state, one or more elements included in the wireless communication device 102 (e.g., processing circuitry 302, processor 304, memory 306, transceiver 308, location determination module 310, etc.) are active such that the wireless communication device 102 can monitor a timing measurement exchange. In this regard, sending the initiation message causes the wireless communication device 102 to operate in an awake state for a duration of time sufficient to monitor a timing measurement exchange. The formatting of the initiation message can be based on a message that is defined in a wireless communication protocol. The wireless communication protocol can specify that the wireless communication device operates in an awake state subsequent to sending the message. For example, an IEEE 802.11 wireless communication protocol can specify that a wireless communication device operates in an awake state for a duration of time after sending a request in order to receive any responses to the request. In some embodiments, the initiation message can be based on an existing message, which can be extended/modified/formatted for an additional purpose to function as an initiation message defined for triggering initiation of a timing measurement exchange. In some embodiments, the initiation message can be a dedicated message for triggering initiation of a timing measurement exchange.

In some embodiments, the initiation message can be a message that can be used for active scanning by the wireless communication device 102. For example, the initiation message can take the form of a probe request. The probe request can include a “wildcard” service set identifier (SSID). For example, in an IEEE 802.11 wireless communication protocol, a probe request having an SSID information field with a length of 0 octets can indicate the “wildcard” SSID. The probe request that includes the “wildcard” SSID can be received by access points within a range of the wireless communication device 102, regardless of whether the access points are known to the wireless communication device 102. In this regard, the probe request can be received by access point 104 and/or access point 106, regardless of whether one or both of the access points 104/106 are known to the wireless communication device 102. Any access point receiving the probe request can initiate a timing measurement exchange and, in some cases, multiple access points (e.g., both the access point 104 and the access point 106) can initiate a timing measurement exchange in response to receipt of the probe request. The wireless communication device 102 can remain in an awake state while waiting for a probe response for a sufficient amount of time to monitor the resulting timing measurement exchange. In some embodiments, the probe request can be used when the wireless communication device 102 is not associated with an access point, or at least when the wireless communication device 102 is not associated with either the access point 104 or the access point 106. In some embodiments, in which a probe request is used to trigger initiation of a timing measurement exchange, a probe request frame can be extended/formatted to include an information element that indicates that initiation of a timing measurement exchange is requested. Thus, when a probe request is sent for a purpose other than initiation of a timing measurement exchange, an access point receiving the probe request can avoid performing a timing measurement exchange when the probe request does not include an information element indicating that initiation of a timing measurement exchange is requested.

In some embodiments, the initiation message sent in step 504 can be sent while the wireless communication device 102 is awake and associated with an access point. In such embodiments, the initiation message can be directed to the access point with which the wireless communication device 102 is associated (e.g., access point 104 or access point 106) to trigger the access point to initiate a timing measurement exchange with one or more access points. For example, the initiation message can include an authentication request frame, such as can be used during association and/or roaming. The authentication request frame can be extended/formatted to include an information element indicating that initiation of a timing measurement exchange is requested. Thus, when an authentication request is sent for a purpose other than initiation of a timing measurement exchange, an access point receiving the authentication request can avoid performing a timing measurement exchange when the authentication request does not include an information element indicating that initiation of a timing measurement exchange is requested.

Step 506 can include the wireless communication device 102 monitoring a timing measurement exchange between a plurality of access points, where the timing measurement exchange can be initiated in response to the initiation message sent in step 504. For example, the wireless communication device 102 can receive timing report messages (e.g., R1, R2 and R3) while monitoring a timing measurement exchange 108 between the access point 104 and the access point 106. Step 508 can include receiving location information from one or more access points. For example, the location information can include latitude and longitude coordinates of a particular access point. The location information received at step 508 can be used in conjunction with the information obtained while monitoring the timing measurement exchange of step 506 to determine a location of the wireless communication device 102.

Step 510 can include the wireless communication device 102 determining a location of wireless communication device 102 based on the timing measurement exchange. For example, the wireless communication device 102 can use times at which one or more timing messages (e.g., TM) and one or more acknowledgement messages (e.g., ACK) are sent by one or more access points and the times at which the timing messages and acknowledgement messages are received to determine a distance 112 to the access point 104 and a distance 114 to the access point 106.

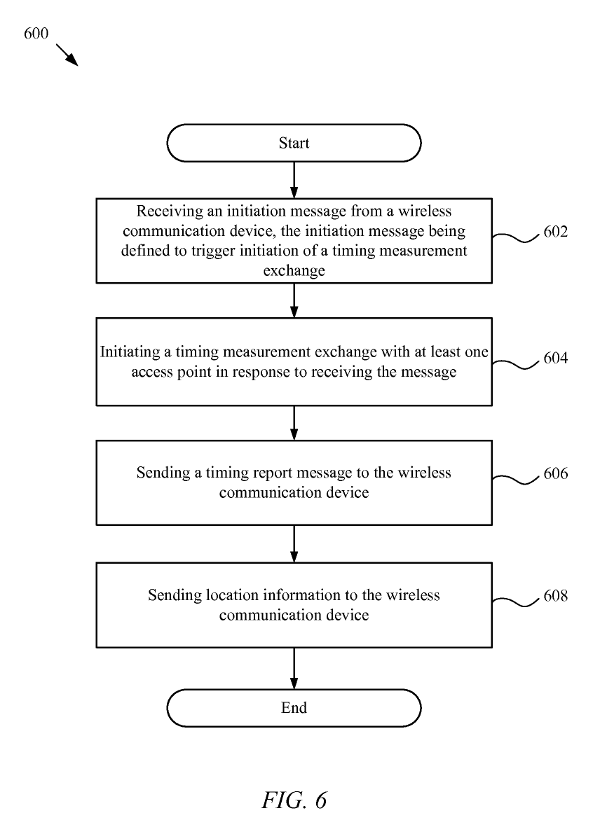

FIG. 6 illustrates a flowchart 600 of a method for facilitating a location determination for a wireless communication device, in accordance with some embodiments. In this regard, FIG. 6 illustrates steps that can be performed by an access point, such as the access point 104 and/or the access point 106, in accordance with various embodiments. One or more of processing circuitry 402, processor 404, memory 406, transceiver 406, or timing measurement module 410 can, for example, provide means for performing the operations illustrated in and described with respect to FIG. 6.

Step 602 can include an access point receiving an initiation message sent by a wireless communication device. The received message can be defined to trigger initiation of a timing measurement exchange. For example, step 602 can include the access point receiving the initiation message sent by the wireless communication device 102 in step 504 of FIG. 5. Step 604 can include the access point initiating a timing measurement exchange with at least one other access point in response to receiving the initiation message. For example, step 604 can include the access point 104 initiating a timing measurement exchange with the access point 106 and/or one or more other neighboring access points. The access point 104 initiates the timing measurement exchange by sending a timing message (e.g., TM) to the access point 106. In some embodiments, in which an existing message is extended/modified for the additional purpose of triggering initiation of a timing measurement exchange, and an information element is added to the existing message to indicate whether the message is defined as a request to initiate a timing measurement exchange, the access point can omit performance of step 604 in an instance in which the received message does not include an information element indicating that initiation of a timing measurement exchange is requested.

Step 606 includes sending a timing report message (e.g., R1) to the wireless communication device. The timing report message can be sent while the timing measurement exchange occurs. Alternatively, the timing report message can be sent after the timing measurement exchange is completed. The timing report message can include one or more times values associated with the timing measurement exchange. These time values can take the form of timestamps (e.g., 10:48:34 AM PST) or durations of time (e.g., 4 minutes, 2 seconds). For example, the timing report message can include times associated with a round-trip-time of the timing measurement exchange. Step 608 can include sending the wireless communication device location information. The location information can include location coordinates, a time of flight with respect to another access point, and a distance with respect to another access point.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for determining a location of a wireless local area network (WLAN) station configured to communicate with a first access point and a second access point, the method comprising:
at the WLAN station:
sending a request to the first access point to cause the first access point to initiate a timing measurement exchange with the second access point;
receiving, from the first access point, a first report message based on the timing measurement exchange;
receiving, from the second access point, a second report message based on the timing measurement exchange; and
determining a location of the WLAN station based on the first report message and the second report message.

2. The method as recited in claim 1, wherein the request comprises a probe request frame having an information element that causes the first access point to initiate the timing measurement exchange with the second access point.

3. The method as recited in claim 1, wherein subsequent to sending the request to the first access point, the WLAN station operates in an awake state for at least a portion of time during the timing measurement exchange.

4. The method as recited in claim 1, wherein the request comprises a probe request including a wildcard service set identifier (SSID).

5. The method as recited in claim 1, wherein the request comprises an authentication request frame having an information element that causes the first access point to initiate the timing measurement exchange with the second access point.

6. The method as recited in claim 1, further comprising receiving location information from the first access point or the second access point, and wherein determining the location of the WLAN station is further based on the location information.

7. The method as recited in claim 1, wherein prior to sending the request to the first access point, the WLAN station is not associated with the first access point.

8. The method as recited in claim 1, wherein determining the location of the WLAN station comprises calculating a difference between (i) a first distance between the WLAN station and the first access point and (ii) a second distance between the WLAN station and the second access point.

9. The method as recited in claim 1, wherein determining the location of the WLAN station is further based on a first time indicating when the WLAN station received the first report message and based on a second time indicating when the WLAN station received the second report message.

10. A method for determining a location of a wireless communication device configured to communicate with a first access point and a second access point, the method comprising:
at the first access point:
receiving an initiation message from the wireless communication device, the initiation message indicating the wireless communication device requests that the first access point initiate a timing measurement exchange;
in response to the receiving the initiation message, initiating the timing measurement exchange by sending a timing message to the second access point;
sending to the wireless communication device a first report message based on the sent timing message; and
receiving an acknowledgement message from the second access point.

11. The method as recited in claim 10, wherein the initiation message comprises a probe request or an authentication request.

12. The method as recited in claim 10, wherein sending the timing message to the second access point causes the second access point to send a second report message to the wireless communication device.

13. The method as recited in claim 10, further comprising subsequent to receiving the acknowledgement message, sending to the wireless communication device a third report message including a time indicating when the acknowledgement message was received by the first access point.

14. The method as recited in claim 10, wherein prior to receiving the initiation message, the wireless communication device is not associated with the first access point.

15. The method as recited in claim 10, further comprising sending to the wireless communication device location information identifying a location of the first access point.

16. A non-transitory computer readable storage medium configured to store instructions that, when executed by a processor included in a wireless communication device, cause the wireless communication device to:
format an initiation message defined to cause a timing measurement exchange between a plurality of access points;
send the initiation message to at least one of the plurality of access points, wherein sending the initiation message (i) causes the timing measurement exchange between the plurality of access points, and (ii) causes the wireless communication device to operate in an awake state for at a least a portion of time during the timing measurement exchange;
monitor the timing measurement exchange; and
determine a location of the wireless communication device based on information received from the plurality of access points during the timing measurement exchange.

17. The non-transitory computer readable storage medium as recited in claim 16, wherein the instructions, when executed by the processor, further cause the wireless communication device to receive at least two timing report messages from one or more of the plurality of access points while monitoring the timing measurement exchange.

18. The non-transitory computer readable storage medium as recited in claim 16, wherein the wireless communication device communicates with the plurality of access points in accordance with an Institute of Electrical and Electronics Engineers (IEEE) 802.11 wireless communication protocol.

19. The non-transitory computer readable storage medium as recited in claim 18, wherein the format of the initiation message is based on a request message defined in the IEEE 802.11 wireless communication protocol that causes the wireless communication device to operate in the awake state for a period of time subsequent to sending the request message.

20. The non-transitory computer readable storage medium as recited in claim 16, wherein determining the location comprises calculating a location based on a hyperbolic navigation operation.
